(19) United States
(12) Patent Application Publication
(10) Pub. No.: US 2025/0105361 A1
(43) Pub. Date: Mar. 27, 2025

(54) ALL-SOLID-STATE BATTERY AND MANUFACTURING METHOD THEREOF

(71) Applicant: SAMSUNG ELECTRO-MECHANICS CO., LTD., Suwon-si, Gyeonggi-do (KR)

(72) Inventors: Youngjin Hwang, Suwon-si, Gyeonggi-do (KR); Youngil Lee, Suwon-si, Gyeonggi-do (KR); Kyunglock Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/576,551

(22) PCT Filed: Dec. 11, 2023
(86) PCT No.: PCT/KR2023/020275

§ 371 Date: Jan. 4, 2024

(30) Foreign Application Priority Data
Mar. 7, 2023 (KR) 10-2023-0029935
Aug. 11, 2023 (KR) 10-2023-0105308

(51) Int. Cl. H01M 10/0585; H01M 4/04; H01M 4/75; H01M 50/46

(52) U.S. Cl. CPC H01M 10/0585; H01M 4/0404; H01M 4/0407; H01M 4/75; H01M 50/46

(57) ABSTRACT

An all-solid-state battery includes: a solid electrolyte layer; and a plurality of electrode layers disposed in a stacking direction with the solid electrolyte layer interposed between the plurality of electrode layers. At least one of the plurality of electrode layers includes: a current collector in which an active material accommodating portion is disposed; and an electrode active material layer disposed in the active material accommodating portion and also disposed at at least one surface of the current collector. The active material accommodating portion may include a plurality of slits provided in the current collector.

### CROSS-REFERENCE TO RELATED APPLICATION

This application claims priority to and the benefit of Korean Patent Application No. 10-2023-0029935 filed on Mar. 7, 2023 and Korean Patent Application No. 1 10-2023-0105308 filed on Aug. 11, 2023, the entire contents of which are incorporated herein by reference.

### TECHNICAL FIELD

The present disclosure relates to an all-solid-state battery and a manufacturing method thereof.

### BACKGROUND ART

As long-term use of a portable electronic device is common, a high-capacity battery is required, and safety of the battery is required due to popularization of a wearable electronic device. Therefore, development of an all-solid-state battery using a solid electrolyte instead of a liquid electrolyte is actively progressing.

An all-solid-state battery is a battery that replaces the conventional liquid electrolyte with a solid electrolyte, and may greatly reduce the risk of explosion due to the flammability of the liquid electrolyte. The all-solid-state battery does not use the liquid electrolyte so that the all-solid-state battery may operate stably even in harsh environment of relatively high temperature and high pressure. In addition, cells may be stacked without a separate cooling part in the all-solid-state battery so that the all-solid-state battery may realize high energy density in the same volume. Thus, the all-solid-state battery is expected to be used in the future.

### DISCLOSURE OF INVENTION

### Technical Problem

One aspect of an embodiment is to provide an all-solid-state battery capable of increasing an amount of an active material within a given volume to increase energy density and capacity, and a manufacturing method of the all-solid-state battery.

However, a problem to be solved by embodiments of the present disclosure is not limited to the above-described problem, and may be variously expanded in a range of a technical idea included in the present disclosure.

### Solution to Problem

An all-solid-state battery according to an embodiment includes: a solid electrolyte layer; and a plurality of electrode layers disposed in a stacking direction with the solid electrolyte layer interposed between the plurality of electrode layers. At least one of the plurality of electrode layers includes: a current collector that includes a plurality of first current collector portions disposed at a distance from each other by a plurality of slits and a second current collector portion contacting one side end portions of the plurality of first current collector portions in a plane direction; and an electrode active material layer disposed in the plurality of slits and also disposed at at least one surface of the current collector.

The plurality of electrode layers may include a first electrode layer and a second electrode layer alternately disposed in the stacking direction. The second current collector portion of the first electrode layer and the second current collector portion of the second electrode layer may be disposed on opposing sides in a first direction of a cell stack including the plurality of electrode layers.

In the first electrode layer, the plurality of first current collector portions may have a rod shape parallel to the first direction and the second current collector portion may be in contact with the one side end portions of the plurality of first current collector portions in the plane direction.

The second current collector portion may have a rod shape parallel to a second direction of the cell stack, and an edge of the second current collector portion may be exposed to one side surface of the cell stack.

A first external electrode may be disposed at the one side surface of the cell stack to contact the edge of the second current collector portion of the first electrode layer.

A margin portion may be disposed at edges of the first electrode layer except for an edge of the second current collector portion of the first electrode layer which is connected to the first external electrode.

In the second electrode layer, the plurality of first current collector portions may have a rod shape parallel to the first direction and the second current collector portion may be in contact with the other side end portions of the plurality of first current collector portions in the plane direction.

The second current collector portion may have a rod shape parallel to a second direction of the cell stack, and an edge of the second current collector portion may be exposed to the other side surface of the cell stack.

A second external electrode may be disposed at the other side surface of the cell stack to contact the edge of the second current collector portion of the second electrode layer.

A margin portion may be disposed at edges of the second electrode layer except for an edge of the second current collector portion of the second electrode layer which is connected to the second external electrode.

The electrode active material layer may be disposed on opposing surfaces of the current collector in the stacking direction.

An all-solid-state battery according to another embodiment includes: a solid electrolyte layer; and a plurality of electrode layers disposed in a stacking direction with the solid electrolyte layer interposed between the plurality of electrode layers. At least one of the plurality of electrode layers includes: a current collector in which an active material accommodating portion is disposed; and an electrode active material layer disposed in the active material accommodating portion and also disposed at at least one surface of the current collector.

The active material accommodating portion may include a plurality of slits in the current collector. The current collector may include a plurality of first current collector portions disposed at a distance from each other by the plurality of slits and a second current collector portion contacting one side end portions of the plurality of first current collector portions in a plane direction.

A margin portion may be disposed at edges of the at least one of the plurality of electrode layers except for an edge of the second current collector portion of the at least one of the plurality of electrode layers.

The electrode active material layer may include a first layer disposed at the one surface of the current collector, a plurality of second layers disposed in the plurality of slits, and a third layer disposed at the other surface of the current collector. The first layer and the third layer may be integrally connected by the plurality of second layers.

A manufacturing method of the all-solid-state battery according to an embodiment includes: forming an electrode layer on a solid electrolyte layer; and repeatedly stacking the solid electrolyte layer and the electrode layer. The forming of the electrode layer includes: printing a first active material layer on the solid electrolyte layer; printing a current collector that includes a plurality of slits on the first active material layer; printing a plurality of second active material layers to fill the plurality of slits; and printing a third active material layer on the current collector and on the plurality of second active material layers.

The printing of the current collector may include printing the current collector that includes a plurality of first current collector portions disposed at a distance from each other by the plurality of slits and a second current collector portion contacting one side end portions of the plurality of first current collector portions in a plane direction.

The method may further include forming A margin portion at edges of the electrode layer except for an edge of the second current collector portion.

The repeatedly stacking the solid electrolyte layer and the electrode layer may include alternately stacking a first electrode layer and a second electrode layer. The second current collector portion of the first electrode layer may be printed to be in contact with the one side end portions of the plurality of first current collector portions in the plane direction. The second current collector portion of the second electrode layer may be printed to be in contact with the other side end portions of the plurality of first current collector portions in the plane direction. The second current collector portion of the first electrode layer and the second current collector portion of the second electrode layer may be disposed on opposing sides in a first direction of a cell stack including the stacked electrode layers.

### Advantageous Effects of Invention

According to the all-solid-state battery of the embodiment, an amount of an active material may be increased without increasing a volume. Accordingly, the all-solid-state battery of the embodiment may increase energy density and capacity within a given volume.

### BRIEF DESCRIPTION OF DRAWINGS

FIG. 1 is a perspective view showing an all-solid-state battery according to an embodiment.

FIG. 2 is a cross-sectional view of the all-solid-state battery cut along line II-II′ of FIG. 1.

FIG. 3 is a cross-sectional view of the all-solid-state battery cut along line III-III′ of FIG. 1.

FIG. 4 is a perspective view of a positive electrode layer of the all-solid-state battery shown in FIG. 1.

FIG. 5 is an exploded perspective view of the positive electrode layer shown in FIG. 4.

FIG. 6 is a perspective view of a negative electrode layer of the all-solid-state battery shown in FIG. 1.

FIG. 7 is an exploded perspective view of the negative electrode layer shown in FIG. 6.

FIGS. 8A to 8E are views illustrating processes of a first step of a manufacturing method of the all-solid-state battery according to an embodiment.

FIGS. 9A to 9E are views illustrating processes of a second step of the manufacturing method of the all-solid-state battery according to an embodiment.

FIG. 10 is a view illustrating a process of a third step of the manufacturing method of the all-solid-state battery according to an embodiment.

### MODE FOR THE INVENTION

Hereinafter, with reference to accompanying drawings, an embodiment of the present disclosure will be described in detail and thus a person of an ordinary skill can easily practice it in the technical field to which the present disclosure belongs. The drawings and description are to be regarded as illustrative in nature and not restrictive. Like reference numerals designate like elements throughout the specification. In addition, in the accompanying drawing, some constituent elements are exaggerated, omitted, or schematically shown, and the size of each constituent element does not fully reflect the actual size.

The accompanying drawing are only for easy understanding of the embodiment disclosed in this specification, and the technical idea disclosed in this specification is not limited by the accompanying drawings, and it should be understood that all changes and equivalents or substitutes are included in the spirit and technical range of the present disclosure.

Terms containing ordinal numbers, such as first, second, and the like can be used to describe various configurations elements, but the constituent elements are not limited by the terms. The terms are used only for the purpose of distinguishing one constituent element from another.

It will be understood that when an element such as a layer, film, region, or substrate is referred to as being “on” or “above” another element, it can be directly on the other element or intervening elements may also be present. In contrast, when an element is referred to as being “directly on” another element, there are no intervening elements present. Further, throughout the specification, the word “on” or “above” a target element will be understood to mean positioned above or below the target element, and will not necessarily be understood to mean positioned “at an upper side” based on an opposite to gravity direction.

Throughout the specification, terms such as “comprise” or “have” are intended to designate that a feature, number, step, operation, constituent element, part, or combination thereof described in the specification exists, and it should be understood as not precluding the possibility of the presence or addition of and one or more other features, numbers, steps, actions, constituent elements, parts, or combinations thereof. In addition, unless explicitly described to the contrary, the word “comprise”, and variations such as “comprises” or “comprising”, will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

Throughout the specification, “connected” does not mean only when two or more constituent elements are directly connected, but also when two or more constituent elements are indirectly connected through another constituent element, or when physically connected or electrically connected, and it may include a case in which substantially integral parts are connected to each other although they are referred to by different names according to positions or functions.

In description of an all-solid-state battery in this specification, a direction in which main components of the all-solid-state battery are stacked is defined as a stacking direction, but may also be a thickness direction. In addition, a direction parallel to a plane perpendicular to the stacking direction may be defined as a plane direction (a planar direction), and the plane direction may include a first direction and a second direction that are orthogonal to each other.

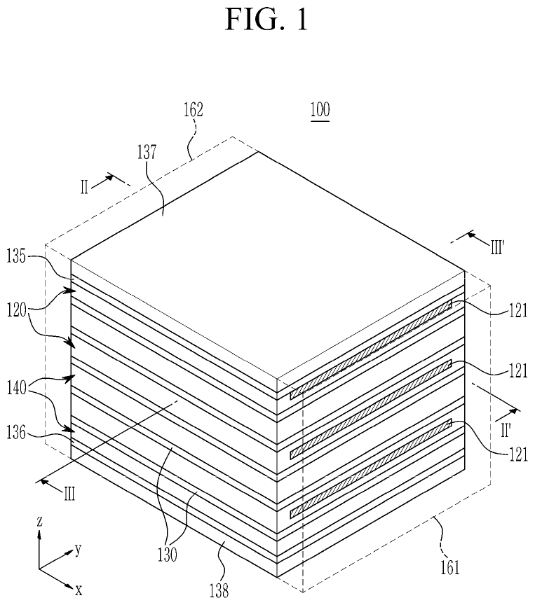

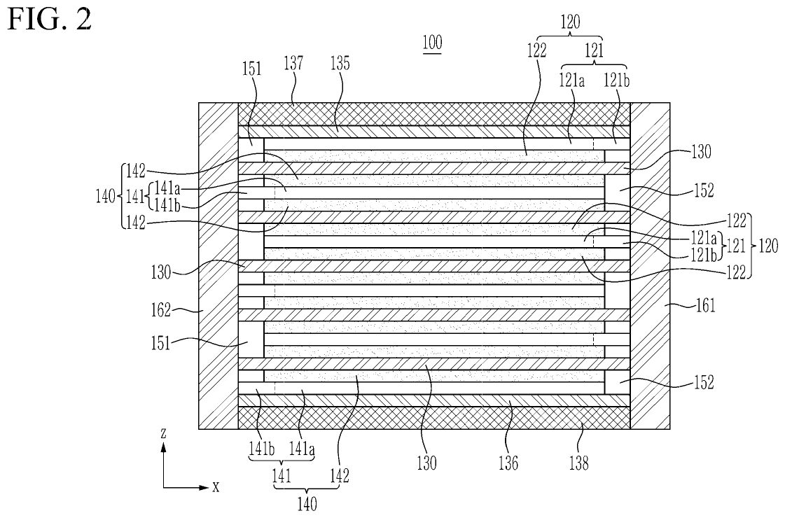

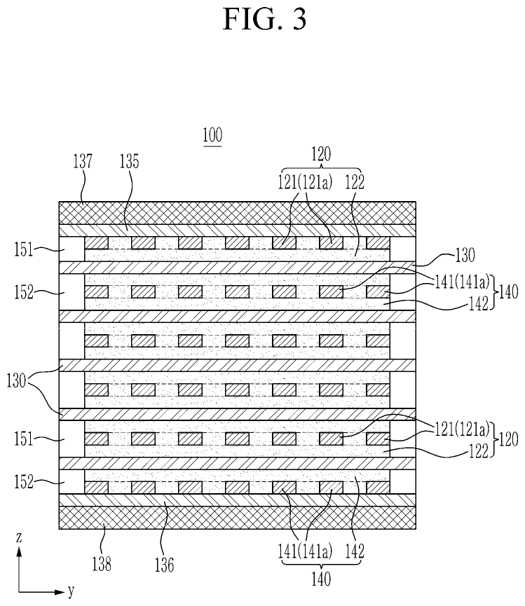

FIG. 1 is a perspective view showing an all-solid-state battery according to an embodiment. FIG. 2 is a cross-sectional view of the all-solid-state battery cut along a line II-II′ of FIG. 1, and FIG. 3 is a cross-sectional view of the all-solid-state battery cut along a line III-III′ of FIG. 1.

Referring to FIGS. 1 to 3, the all-solid-state battery 100 according to the embodiment includes electrode layers 120 and 140 and a solid electrolyte layer 130 disposed adjacent to the electrode layers 120 and 140 in a stacking direction (z direction in the drawings). The electrode layers 120 and 140 may basically include current collectors 121 and 141 extending in the plane direction (x-y direction in the drawings) and electrode active material layers 122 and 142 disposed on at least one surface of the current collectors 121 and 141.

In the present embodiment, the electrode layers 120 and 140 include a positive electrode layer 120 and a negative electrode layer 140 having different polarities. The solid electrolyte layer 130 may include a solidified electrolyte, and may function as a medium for transferring ions between the positive electrode layer 120 and the negative electrode layer 140. The positive electrode layer 120 may be a first electrode layer, and the negative electrode layer 140 may be a second electrode layer. The positive electrode layer 120 may include a positive electrode current collector 121 and a positive electrode active material layer 122 disposed on at least one surface of the positive electrode current collector 121. The negative electrode layer 140 may include a negative electrode current collector 141 and a negative electrode active material layer 142 disposed on at least one surface of the negative electrode current collector 141.

For example, the positive electrode layer 120 disposed at an uppermost portion in the stacking direction may include the positive electrode active material layer 122 disposed on one surface (a lower surface) of the positive electrode current collector 121, and the negative electrode layer 140 disposed at a lowermost portion in the stacking direction may include the negative electrode active material layer 142 disposed on one surface (an upper surface) of the negative electrode current collector 141. In addition, positive electrode layers 120 disposed between the uppermost and lowermost portions may include positive electrode active material layers 122 disposed on both surfaces of the positive electrode current collector 121, and negative electrode layers 140 disposed between the uppermost and lowermost portions may include negative electrode active material layers 142 disposed on both surfaces of the negative electrode current collector 141.

A positive electrode active material included in the positive electrode active material layer 122 may be a material including lithium (Li) ions. The positive electrode active material may reversibly intercalate and deintercalate the lithium ions. That is, the positive electrode active material may serve to provide the lithium ions to the negative electrode when the all-solid-state battery is charged. The positive electrode active material may affect a capacity and an output of the all-solid-state battery.

The positive electrode active material may include, for example, a compound expressed by the following chemical formulae: LiₐA_{l-b}M_{b}D₂ (0.90≤a≤1.8 and 0≤b≤0.5); LiₐE_{l-b}M_{b}O_{2-c}D_{c} (0.90≤a≤1.8, 0≤b≤0.5, and 0≤c≤0.05); LiE_{2-b}M_{b}O_{4-c}D_{c} (0≤b≤0.5 and 0≤c≤0.05); LiₐNi_{1-b-c}Co_{b}M_{c}D_{α} (0.90≤a≤1.8, 0≤b≤0.5, 0≤c≤0.05, and 0<α≤2); LiₐNi_{1-b-c}Co_{b}M_{c}O_{2-α}X_{α} (0.90≤a≤1.8, 0≤b≤0.5, 0≤c≤0.05, and 0<α<2); LiₐNi_{1-b-c}Co_{b}M_{c}O_{2-α}X₂ (0.90≤a≤1.8, 0≤b≤0.5, 0≤c≤0.05, and 0<α<2); LiₐNi_{1-b-c}Mn_{b}M_{c}D_{α} (0.90≤a≤1.8, 0≤b≤0.5, 0≤c≤0.05, and 0<α≤2); LiₐNi_{1-b-c}Mn_{b}M_{c}O_{2-α}X_{α} (0.90≤a≤1.8, 0≤b≤0.5, 0≤c≤0.05, and 0<α<2); LiₐNi_{1-b-c}Mn_{b}M_{c}O_{2-α}X₂ (0.90≤a≤1.8, 0≤b≤0.5, 0≤c≤0.05, and 0<α<2); LiₐNi_{b}E_{c}G_{d}O₂ (0.90≤a≤1.8, 0≤b≤0.9, 0≤c≤0.5, and 0.001≤d≤0.1); LiₐNi_{b}Co_{c}Mn_{d}GₑO₂ (0.90≤a≤1.8, 0≤b≤0.9, 0≤c≤0.5, 0≤d≤0.5, and 0.001≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMnG_{b}O₂ (0.90≤a≤1.8 and 0.001≤b≤0.1); LiₐMn₂G_{b}O₄ (0.90≤a≤1.8 and 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (0≤f≤2); and LiFePO₄. In the chemical formulae, A represents Ni, Co, or Mn, M represents Al, Ni, Co, Mn, Cr, Fe, Mg, Sr, V, Nb, Ti, or a rare-earth element, D represents O, F, S, or P, E represents Co or Mn, X represents F, S, or P, G represents Al, Cr, Mn, Fe, Mg, La, Ce, Sr, or V, Q represents Ti, Mo, or Mn, R represents Cr, V, Fe, Sc, or Y, and J represents V, Cr, Mn, Co, Ni, or Cu.

The positive electrode active material may also include LiCoO₂, LiMnₓO₂ₓ (x=1 or 2), LiNi₁₋ₓMnₓO₂ₓ (0<x<1), LiNi_{1-x-y}CoₓMn_{y}O₂ (0≤x≤0.5 and 0≤y≤0.5), LiFePO₄, TiS₂, FeS₂, TiS₃, or FeS₃, but is not limited thereto.

The positive electrode active material may selectively include a conductive material and a binder. However, since an organic material such as the binder is decomposed during sintering, the organic material may not remain in the positive electrode active material layer of the final positive electrode current collector.

The conductive material is not particularly limited as long as it has conductivity without causing a chemical change in the all-solid-state battery 100. For example, the conductive material may include graphite such as natural graphite, artificial graphite, or the like; a carbon-based material such as carbon black, acetylene black, Ketjen black, channel black, furnace black, lamp black, thermal black, or the like; a conductive fiber such as a carbon fiber, a metal fiber, or the like; carbon fluoride; a metal component such as lithium (Li), tin (Sn), aluminum (Al), nickel (Ni), copper (Cu), or the like, oxide, nitride, or fluoride thereof, or the like; a conductive whisker such as zinc oxide, potassium titanate, or the like; conductive metal oxide such as titanium oxide or the like; or a conductive material such as a polyphenylene derivative or the like.

The binder may be used to improve the bonding strength between the active material, the conductive material, and the like. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorine rubber, or various copolymers, but the present disclosure is not limited thereto.

A negative electrode active material included in the negative electrode active material layer 142 may generate electrical energy by storing and releasing the lithium ions moving from the positive electrode when the all-solid-state battery is discharged. The negative electrode active material may include a carbon-based material, silicon, silicon oxide, a silicon-based alloy, a silicon-carbon-based material composite, tin, a tin-based alloy, a tin-carbon composite, metal oxide, or a combination thereof, and may include a lithium metal and/or lithium metal alloy.

The lithium metal alloy may include lithium and a metal/metalloid that may be alloyed with lithium. For example, the metal/metalloid that may be alloyed with lithium may include Si, Sn, Al, Ge, Pb, Bi, Sb, a Si-AM alloy (where AM is an alkali metal, an alkaline earth metal, a group 13 to 16 element, a transition metal, a rare earth element, or a combination element thereof, and does not include Si), a Sn-AM alloy (where AM is an alkali metal, an alkaline earth metal, a group 13 to 16 element, a transition metal, transition metal oxide such as lithium titanium oxide (Li₄Ti₅O₁₂) or the like, a rare earth element, or a combination element thereof, and does not include Sn), MnOₓ (0<x≤2), or the like.

The element AM may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

Oxides of the metal/metalloid that may be alloyed with lithium may include lithium titanium oxide, vanadium oxide, lithium vanadium oxide, SnO₂, SiOₓ (0<x<2), or the like. For example, the negative electrode active material may include one or more elements selected from the group consisting of a group 13 to 16 element of the periodic table of elements. For example, the negative electrode active material may include one or more elements selected from the group consisting of Si, Ge, and Sn.

The carbon-based material may include crystalline carbon, amorphous carbon, or a mixture thereof. The crystalline carbon may include graphite such as amorphous, plate-shaped, flake-shaped, spherical, or fibrous natural graphite or artificial graphite. The amorphous carbon may include soft carbon (low-temperature calcined carbon), hard carbon, mesophase pitch carbide, calcined coke, graphene, carbon black, fullerene soot, carbon nanotube, a carbon fiber, or the like, but is not limited thereto.

The silicon may be selected from the group consisting of Si, SiOₓ (0<x<2 and for example, x ranges from 0.5 to 1.5), Sn, SnO₂, a silicon-containing metal alloy, and a mixture thereof. For example, the silicon-containing metal alloy may include silicon and one or more of Al, Sn, Ag, Fe, Bi, Mg, Zn, in, Ge, Pb, and Ti.

The negative electrode active material may selectively include a conductive material and a binder.

The conductive material is not particularly limited as long as it has conductivity without causing a chemical change in the all-solid-state battery 100. For example, the conductive material may include graphite such as natural graphite, artificial graphite, or the like; a carbon-based material such as carbon black, acetylene black, Ketjen black, channel black, furnace black, lamp black, thermal black, or the like; a conductive fiber such as a carbon fiber, a metal fiber, or the like; carbon fluoride; a metal component such as lithium (Li), tin (Sn), aluminum (Al), nickel (Ni), copper (Cu), or the like, oxide, nitride, or fluoride thereof, or the like; a conductive whisker such as zinc oxide, potassium titanate, or the like; conductive metal oxide such as titanium oxide or the like; or a conductive material such as a polyphenylene derivative or the like.

The binder may be used to improve the bonding strength between the active material, the conductive material, and the like. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorine rubber, or various copolymers, but the present disclosure is not limited thereto.

The solid electrolyte layer 130 may be adjacently disposed between the positive electrode active material layer 122 of the positive electrode layer 120 and the negative electrode active material layer 142 of the negative electrode layer 140 in the stacking direction. Therefore, a plurality of positive electrode layers 120 and a plurality of negative electrode layers 140 may be alternately disposed within the all-solid-state battery 100, and the solid electrolyte layer 130 may be interposed and stacked between the positive electrode layer 120 and the negative electrode layer 140.

A solid electrolyte included in the solid electrolyte layer 130 may include a glass-ceramic-based electrolyte including lithium halide (LiX (the halogen element (X)═F, Br, Cl, I, or the like)). The glass-ceramic (or a crystallized glass) refers to a crystallographic mixture of amorphous and crystalline materials from which peaks and halos are observed in X-ray diffraction, electron beam diffraction, or the like. Therefore, the glass-ceramic-based electrolyte is an electrolyte that has undergone partial crystallization through sintering and in which amorphous and crystalline materials are mixed.

The glass-ceramic-based electrolyte may be a mixture of an amorphous material and two or more types of crystalline materials. Further, the crystalline materials which are contained in the glass-ceramic-based electrolyte may include a lithium-compound crystalline phase containing lithium.

When the glass-ceramic-based electrolyte is contained, sufficient densification is achieved after sintering, whereby it is possible to realize high ionic conductivity.

The glass-ceramic-based electrolyte may include lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). As a specific example, the glass-ceramic-based electrolyte may include Li₂O—B₂O₃—SiO₂—P₂O₅—GeO₂—LiCl.

On the other hand, the solid electrolyte included in the solid electrolyte layer 130 may include a lithium borosilicate-based electrolyte (hereinafter referred to as an LBSO-based electrolyte). The LBSO-based electrolyte is a glass-state electrolyte, and glass refers to a crystallographically amorphous material from which halos are observed in X-ray diffraction, electron beam diffraction, or the like.

When the LBSO-based electrolyte is contained, it is possible to keep the amorphous state during sintering while lowering the sintering temperature. Therefore, there is an advantage that it is possible to realize high ionic conductivity and reactivity with electrodes is not high. The LBSO-based electrolyte may include lithium (Li), boron (B), silicon (Si), aluminum (Al), phosphorus (P), germanium (Ge), and sulfur (S).

The solid electrolyte included in the solid electrolyte layer 130 may be at least one selected from the group consisting of a Garnet-type, a NASICON-type, a LISICON-type, a perovskite-type, and a LiPON-type.

The Garnet-type solid electrolyte may refer to lithium lanthanum zirconium oxide (LLZO) represented by LiₐLa_{b}Zr_{c}O₁₂ such as Li₇La₃Zr₂O₁₂ or the like, and the NASICON-type solid electrolyte may refer to lithium-aluminum titanium-phosphate (LATP) Li₁₊ₓAlₓTi₂₋ₓ (PO₄)₃ (0<x<1) produced by introducing Ti into a Li₁₊ₓAlₓM₂₋ₓ PO₄₃ (LAMP) (0<x<2 and M is Zr, Ti, or Ge)-type compound, lithium-aluminum-germanium-phosphate (LAGP) represented by Li₁₊ₓAlₓGe₂₋ₓ(PO₄)₃ (0<x<1) such as Li_{1.3}Al_{0.3}Ge_{1.7}(PO₄)₃ or the like containing an excess amount of lithium, and/or lithium-zirconium-phosphate (LZP) of LiZr₂(PO₄)₃.

The LISICON-type solid electrolyte may refer to solid solution oxide represented by xLi₃AO₄-(1-x)Li₄BO₄ (A: P, As, V, etc. and B: Si, Ge, Ti, etc.), such as Li₄Zn(GeO₄)₄, Li₁₀GeP₂O₁₂ (LGPO), Li_{3.5}Si_{0.5}P_{0.5}O₄, Li_{10.42}Si(Ge)_{1.5}P_{1.5}Cl_{0.08}O_{11.92}, etc., and solid solution sulfide represented by Li₄₋ₓM_{1-y}M′_{y}S₄ (M=Si or Ge and M′=P, Al, Zn, or Ga), such as Li₂S—P₂S₅, Li₂S—SiS₂, Li₂S—SiS₂—P₂S₅, Li₂S—GeS₂, etc.

The perovskite-based solid electrolyte may refer to lithium lanthanum titanate oxide (LLTO) represented by Li₃ₓLa_{2/3-x□1/3-2x}TiO₃ (0<x<0.16 and □ represents a vacancy), such as Li_{1/8}La_{5/8}TiO₃ or the like, and the LiPON-type solid electrolyte may refer to nitride like lithium phosphorous oxynitride such as Li_{2.8}PO_{3.3}N_{0.46} or the like.

The positive electrode layer 120, the solid electrolyte layer 130, and the negative electrode layer 140 may be stacked as described above to form a cell stack of the all-solid-state battery 100. An outer insulating layer 135 covering the positive electrode current collector 121 may be disposed at an upper outermost portion of the cell stack, and an outer insulating layer 136 covering the negative electrode current collector may be disposed at the lower outermost portion of the cell stack. In addition, protective layers 137 and 138 including an insulating material may be additionally disposed outside the outer insulating layers 135 and 136 to prevent ion leakage and secure insulation performance.

One side edge of the positive electrode layer 120 (for example, one side edge of the positive electrode current collector 121) may be exposed to one side surface (a right-side surface) of the cell stack, and one side edge of the negative electrode layer 140 (for example, one side edge of the negative electrode current collector 141) may be exposed to the other side surface (a left-side surface) of the cell stack. One side surface and the other side surface of the cell stack may be both side surfaces facing each other in the first direction (x direction in the drawings) among the plane direction.

An external positive electrode 161 may be disposed at one side surface of the cell stack to be connected to the plurality of positive electrode layers 120, and an external negative electrode 162 may be disposed at the other side surface of the cell stack to be connected to the plurality of negative electrode layers 140. Margin portions 151 and 152 are regions between the positive electrode layer 120 and the external negative electrode 162 and between the negative electrode layer 140 and the external positive electrode 161. That is, the positive electrode margin portion 151 is the region between the external negative electrode 162 and the positive electrode layer 120, and the negative electrode margin portion 152 is the region between the external positive electrode 161 and the negative electrode layer 140.

In the positive electrode margin portion 151 and the negative electrode margin portion 152, a material (that is, an insulating material) having low ionic conductivity and low electrical conductivity, i.e., an insulating material may be present, and a material having ionic conductivity (or electrical conductivity) similar to the ionic conductivity (or electrical conductivity) of the solid electrolyte may be present. For example, when a material having ionic conductivity (or electrical conductivity) similar to the ionic conductivity (or electrical conductivity) of the solid electrolyte is present in the region, that material may be a material identical to or different from the solid electrolyte in other regions. As another example, a material having ionic conductivity (or electrical conductivity) similar to the ionic conductivity (or electrical conductivity) of the solid electrolyte and an insulating material may coexist in the region.

The external positive electrode 161 may be a first external electrode, and the external negative electrode 162 may be a second external electrode.

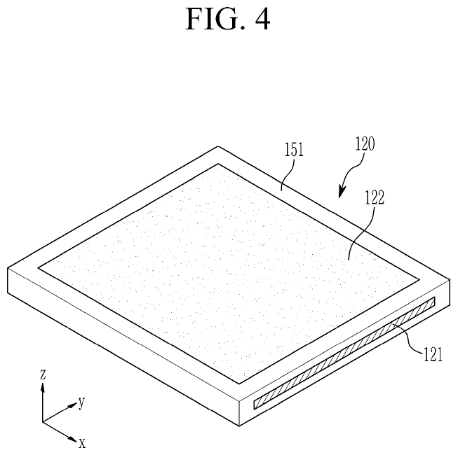

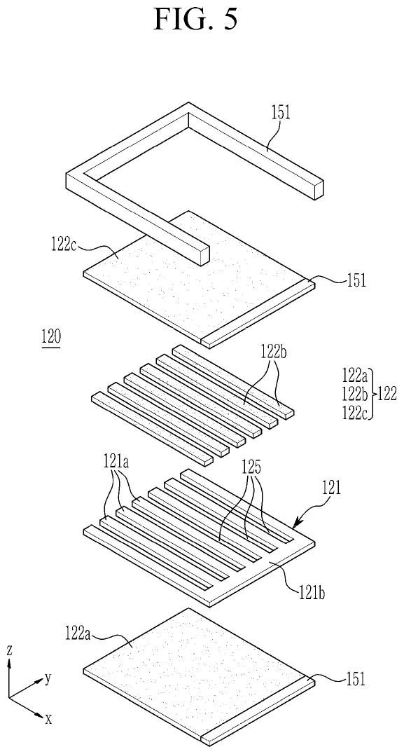

FIG. 4 is a perspective view of the positive electrode layer of the all-solid-state battery shown in FIG. 1, and FIG. 5 is an exploded perspective view of the positive electrode layer shown in FIG. 4.

Referring to FIGS. 4 and 5, the positive electrode layer 120 includes the positive electrode current collector 121 and the positive electrode active material layer 122. The positive electrode current collector 121 may include a plurality of first current collector portions 121a disposed at a distance from each other by a plurality of slits 125 and a second current collector portion 121b contacting one side end portion of the plurality of first current collector portions 121a in the plane direction. The positive electrode active material layer 122 may fill the plurality of slits 125 and may be disposed on at least one surface of the positive electrode current collector 121. FIGS. 4 and 5 illustrate the positive electrode active material layers 122 disposed at both surfaces of the positive electrode current collector 121.

For example, the positive electrode current collector 121 may be made of stainless steel, nickel (Ni), copper (Cu), tin (Sn), aluminum (Al), or an alloy thereof, but is not limited thereto.

Additionally, the positive electrode current collector 121 may be coated with an oxidation-resistant metal or an oxidation-resistant alloy film to prevent oxidation.

The positive electrode current collector 121 may be made of a carbon-based material. The positive electrode current collector 121 may be made of a conductive carbon material. The conductive carbon material may include a conductive fiber such as graphite, carbon nanotube (CNT), a vapor grown carbon fiber (VGCF), or the like, or conductive carbon such as carbon black or the like.

On the other hand, the positive electrode current collector may also include one or more types of solid electrolytes.

Each of the plurality of slits 125 may have a rod shape parallel to the first direction, and the plurality of slits 125 may have the same length and the same width. Each of the plurality of first current collector portions 121a may have a rod shape parallel to the first direction, and the plurality of first current collector portions 121a may have the same length and the same width, but the present disclosure is not limited to this example. The plurality of slits 125 may be disposed side by side along the second direction (y direction in the drawings), and the first current collector portion 121a and the slit 125 may be alternately disposed one by one along the second direction.

The second current collector portion 121b may contact one side end portion (a right side end portion) of the plurality of first current collector portions 121a in the plane direction to be integrally connected to the plurality of first collector portions 121a. The second current collector portion 121b may have a rod shape parallel to the second direction, and an edge of the second current collector portion 121b may be exposed to one side surface (the right-side surface) of the cell stack to contact the external positive electrode 161. The plurality of first current collector portions 121a and the second current collector portion 121b may form a comb-shaped positive electrode current collector 121.

The positive electrode active material layer 122 may fill the plurality of slits 125 and may be disposed on both surfaces of the positive electrode current collector 121. That is, the positive electrode active material layer 122 may comprise a multi-layer structure of a first layer 122a disposed on a lower surface of the positive electrode current collector 121, a second layer 122b that fills the plurality of slits 125, and a third layer 122c disposed on an upper surface of the positive electrode current collector 121. The first layer 122a and the third layer 122c may be integrally connected by the second layer 122b. The plurality of slits 125 disposed at the positive electrode current collector 121 are active material accommodating portions, and the second layer 122b of the positive electrode active material layer 122 is accommodated in the plurality of slits 125.

In the positive electrode layer 120, the positive electrode margin portion 151 may be disposed at the remaining edge except for an edge of the second current collector portion 121b to be connected to the external positive electrode 161. For example, the positive electrode margin portion 151 may be disposed at three edges of four edges of the positive electrode layer 120 except for one side edge (a right side edge) where the edge of the second current collector portion 121b is disposed. In addition, the positive electrode margin portion 151 may be disposed to contact both surfaces of the second current collector portion 121b. Positive electrode margin portions 151 disposed on both surfaces of the second current collector portion 121b may contact the first layer 122a and the third layer 122c of the positive electrode active material layer 122 in the plane direction.

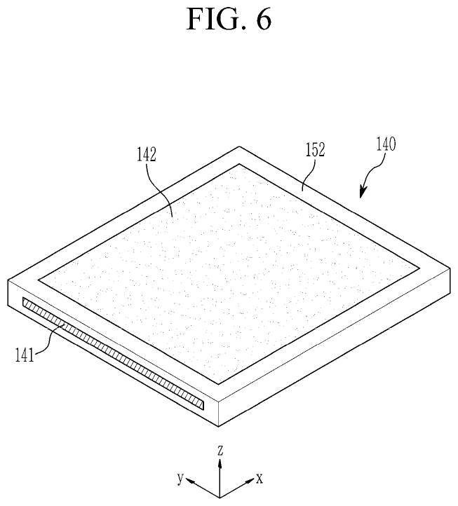

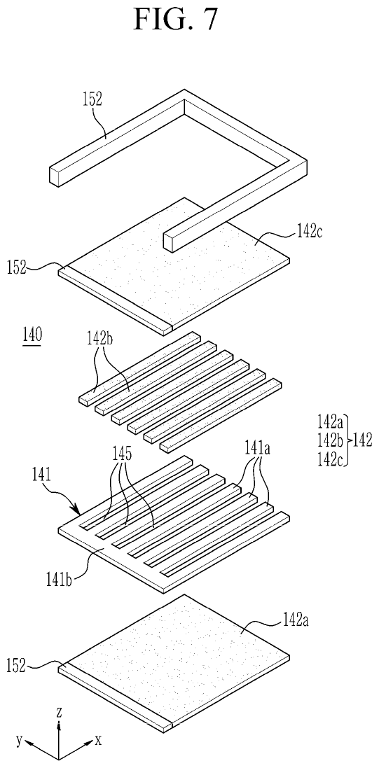

FIG. 6 is a perspective view of the negative electrode layer of the all-solid-state battery shown in FIG. 1, and FIG. 7 is an exploded perspective view of the negative electrode layer shown in FIG. 6.

Referring to FIGS. 6 and 7, the negative electrode layer 140 includes the negative electrode current collector 141 and the negative electrode active material layer 142. The negative electrode current collector 141 may include a plurality of first current collector portions 141a disposed at a distance from each other by a plurality of slits 145 and a second current collector portion 141b in contact with one side end portion of the plurality of first current collector portions 141a in the plane direction. The negative electrode active material layer 142 may fill the plurality of slits 145 and may be disposed on at least one surface of the negative electrode current collector 141. FIGS. 6 and 7 illustrate the negative electrode active material layers 142 disposed on both surfaces of the negative electrode current collector 141.

For example, the negative electrode current collector 141 may be made of stainless steel, nickel (Ni), copper (Cu), tin (Sn), aluminum (Al), or an alloy thereof, but is not limited thereto.

Additionally, the negative electrode current collector 141 may be coated with an oxidation-resistant metal or an oxidation-resistant alloy film to prevent oxidation.

Like the positive electrode current collector 121, the negative electrode current collector 141 may be made of a conductive carbon-based material, and may include one or more types of solid electrolytes. The negative electrode current collector 141 may be the same as the negative electrode active material.

Each of the plurality of slits 145 may have a rod shape parallel to the first direction, and the plurality of slits 145 may have the same length and the same width. Each of the plurality of first current collector portions 141a may have a rod shape parallel to the first direction, and the plurality of first current collector portions 141a may have the same length and the same width, but the present disclosure is not limited to this example. The plurality of slits 145 may be disposed side by side along the second direction, and the first current collector portion 141a and the slit 145 may be alternately disposed one by one along the second direction.

The second current collector portion 141b may contact one side end portion (a left side end portion) of the plurality of first collector portions 141a in the plane direction to be integrally connected to the plurality of first collector portions 141a. The second current collector portion 141b may have a rod shape parallel to the second direction, and an edge of the second current collector portion 141b may be exposed to the other side surface (the left-side surface) of the cell stack to contact the external negative electrode 162. The plurality of first current collector portions 141a and the second current collector portion 141b may form a comb-shaped negative electrode current collector 141.

The negative electrode active material layer 142 may fill the plurality of slits 145 and may be disposed on both surfaces of the negative electrode current collector 141. That is, the negative electrode active material layer 142 may comprise a multi-layer structure of a first layer 142a disposed on a lower surface of the negative electrode current collector 141, a second layer 142b that fills the plurality of slits 145, and a third layer 142c disposed on an upper surface of the negative electrode current collector 141. The first layer 142a and the third layer 142c may be integrally connected by the second layer 142b. The plurality of slits 145 disposed at the negative electrode current collector 141 are active material accommodating portions, and the second layer 142b of the negative electrode active material layer 142 is accommodated in the plurality of slits 145.

In the negative electrode layer 140, the negative electrode margin portion 152 may be disposed at the remaining edge except for an edge of the second current collector portion 141b to be connected to the external negative electrode 162. For example, the negative electrode margin portion 152 may be disposed at three edges of four edges of the negative electrode layer 140 except for one side edge (a left side edge) where the edge of the second current collector portion 141b is disposed. In addition, the negative electrode margin portion 152 may be disposed to contact both surfaces of the second current collector portion 141b. Negative electrode margin portions 152 disposed on both sides of the second current collector portion 141b may contact the first layer 142a and the third layer 142c of the negative electrode active material layer 142 in the plane direction.

Referring to FIGS. 4 to 7, in the positive electrode layer 120 and the negative electrode layer 140 described above, the current collectors 121 and 141 include the plurality of slits 125 and 145 to accommodate the active material layers 122 and 142. The current collectors 121 and 141 that conduct electrons do not directly contribute to a capacity of the all-solid-state battery 100, but in the all-solid-state battery 100 according to the present embodiment, the current collectors 121 and 141 implement an effect of filling portions of their volume with an active material. Thus, the capacity may be increased by increasing an amount of the active material without expanding a volume of the all-solid-state battery 100.

In a conventional all-solid-state battery, a current collector is formed in a simple quadrangular sheet shape, and an active material layer is disposed on at least one surface of the sheet-shaped current collector. When the conventional all-solid-state battery and the all-solid-state battery 100 of the embodiment have the same volume, the all-solid-state battery 100 of the embodiment may have a larger amount of active material than the conventional all-solid-state battery so that the all-solid-state battery 100 of the embodiment increases energy density and capacity compared with the conventional all-solid-state battery.

For example, if the area of each of the first and second layers, which are disposed on both surfaces of the current collector, among the active material layer is 0.9025 cm² and the thickness of each of the first and second layers is 0.0007 cm, the volume of each of the first and second layers is 0.000632 cm³. If the ratio of active material in the volume of each of the first and second layers is 55 vol % and the capacity of lithium cobalt oxide (LCO or LiCoO₂) is 670.6 mAh/cm³, the capacity of each of the first and second layers is calculated to be approximately 0.233 mAh.

If a sheet-shaped current collector without slits has an area of 0.9025 cm² and a thickness of 0.0003 cm, the volume of the current collector is 0.000271 cm³. For such a collector, assuming that slits occupy 50% of the volume of the current collector and the slits are filled with the third layer of the active material layer, the capacity of the third layer is calculated to be approximately 0.05 mAh. In the same way, assuming that slits occupy 70% of the volume of the current collector and the slits are filled with the third layer of the active material layer, the capacity of the third layer is calculated to be approximately 0.07 mAh.

As a result, when the third layer occupies 50% of the volume of the current collector, the electrode layer may show an increase in capacity of approximately 10.7%, and when the third layer occupies 70% of the volume of the current collector, the electrode layer may show an increase in capacity of approximately 15%.

Next, a method for manufacturing the all-solid-state battery 100 having the above configuration will be described.

The manufacturing method of the all-solid-state battery 100 according to an embodiment includes a first step of forming the positive electrode layer 120 on the solid electrolyte layer 130, a second step of forming the negative electrode layer 140 on the solid electrolyte layer 130, and a third step of alternately stacking the positive electrode layer 120 and the negative electrode layer 140 with the solid electrolyte layer 130 interposed between the positive electrode layer 120 and the negative electrode layer 140. The positive electrode layer 120 may be a first electrode layer, and the negative electrode layer 140 may be a second electrode layer. The ordering of the first step and the second step is for convenience only, and does not imply a strict temporal precedence.

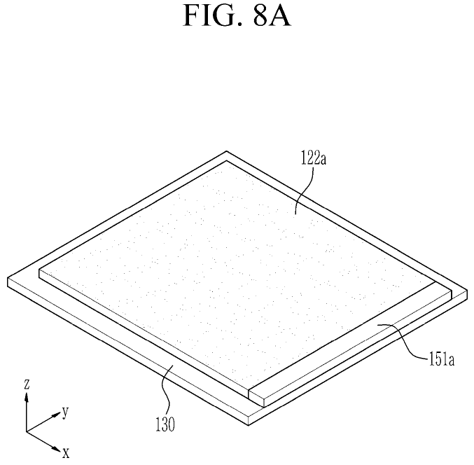

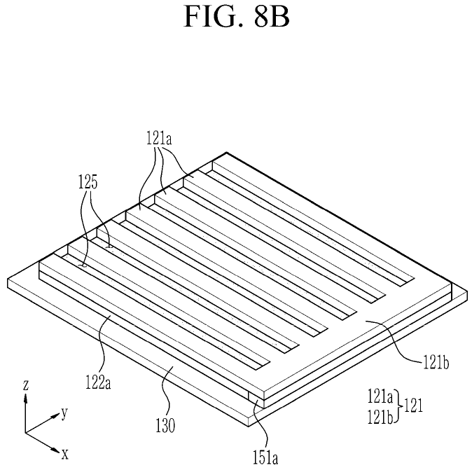

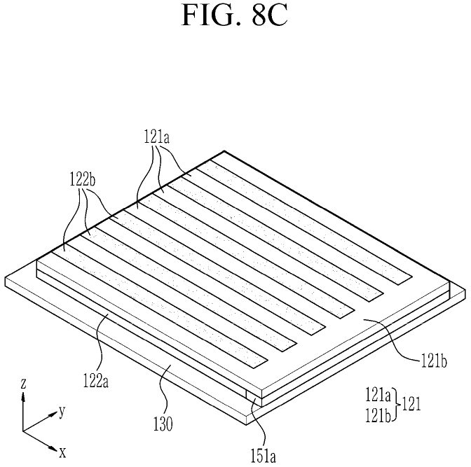

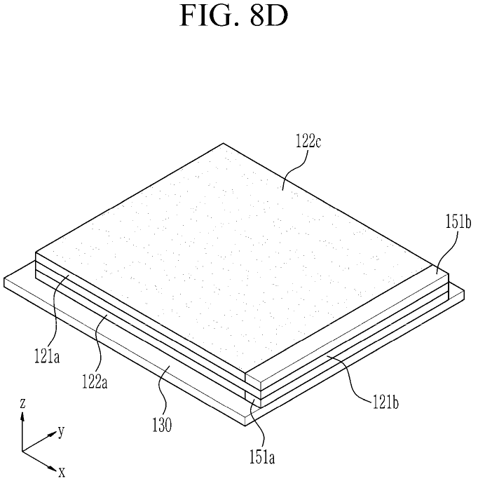

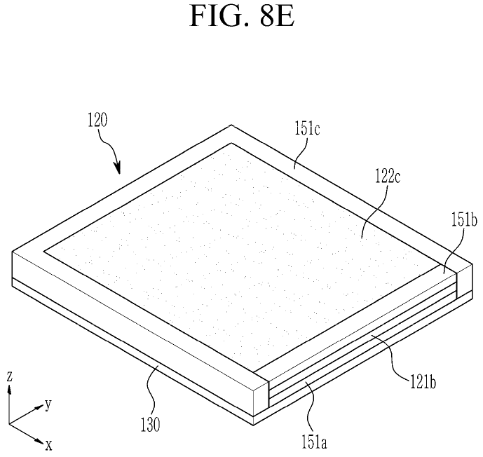

FIGS. 8A to 8E are views illustrating processes of the first step.

Referring to FIG. 8A, the solid electrolyte layer 130 may be prepared, and the first layer 122a may be formed by printing an active material paste on the solid electrolyte layer 130 and then drying the active material paste. The first layer 122a may be a first active material layer. Subsequently, a first margin portion 151a may be formed by printing an insulating paste on the solid electrolyte layer 130 and then drying the insulating paste. The first margin portion 151a may contact one side edge (a right side edge) of the first layer 122a in the plane direction. On the other hand, the first margin portion 151a may be made of a material having ionic conductivity (or electrical conductivity) similar to the ionic conductivity (or electrical conductivity) of the solid electrolyte, and may be made of the material with ionic conductivity (or electrical conductivity) similar to the ionic conductivity (or electrical conductivity) of the solid electrolyte and an insulating material.

Referring to FIG. 8B, the current collector 121 may be formed by printing and then drying a conductive paste on the first layer 122a and the first margin portion 151a. The current collector 121 may include the plurality of first current collector portions 121a disposed at a distance from each other by the plurality of slits 125 and the second current collector portion 121b contacting one side end portion (a right side end portion) of the plurality of first current collector portions 121a in the plane direction. The plurality of first current collector portions 121a may have a rod shape parallel to the first direction, and the second current collector portion 121b may have a rod shape parallel to the second direction.

Referring to FIG. 8C, the second layer 122b may be formed by printing an active material paste in the plurality of slits 125 and then drying the paste. The second layer 122b may be a second active material layer. The second layer 122b may be in contact with the first layer 122a in the stacking direction, and may completely fill the plurality of slits 125.

Referring to FIG. 8D, the third layer 122c may be formed by printing an active material paste on the current collector 121 and the second layer 122b and then drying the paste. The third layer 122c may be a third active material layer. The third layer 122c may cover all of the plurality of first current collector portions 121a, all of a plurality of second layers 122b, and a portion of the second current collector portion 121b. The third layer 122c may be in contact with the plurality of second layers 122b in the stacking direction. Subsequently, a second margin portion 151b may be formed by printing an insulating paste on the second current collector portion 121b and then drying the paste. The second margin portion 151b may contact one side edge (a right side edge) of the third layer 122c in the plane direction. On the other hand, the second margin portion 151b may be made of a material having ionic conductivity (or electrical conductivity) similar to the ionic conductivity (or electrical conductivity) of the solid electrolyte, and may be made of the material with ionic conductivity (or electrical conductivity) similar to the ionic conductivity (or electrical conductivity) of the solid electrolyte and an insulating material.

Referring to FIG. 8E, a third margin portion 151c may be formed by printing an insulating paste on three edges of four edges of a stack including the first to third layers 122a, 122b, and 122c, the first and second margin portions 151a and 151b, and the current collector 121 except for one side edge (a right side edge) where the edge of the second current collector portion 121b is disposed and then drying the insulating paste. The third margin portion 151c may contact the three edges of the stack in the plane direction, and the third margin portion 151c may have the same thickness as the stack. On the other hand, the third margin portion 151c may be made of a material having ionic conductivity (or electrical conductivity) similar to the ionic conductivity (or electrical conductivity) of the solid electrolyte, and may be made of the material with ionic conductivity (or electrical conductivity) similar to the ionic conductivity (or electrical conductivity) of the solid electrolyte and an insulating material.

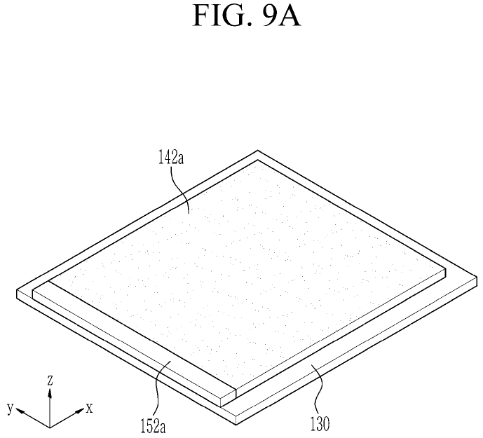

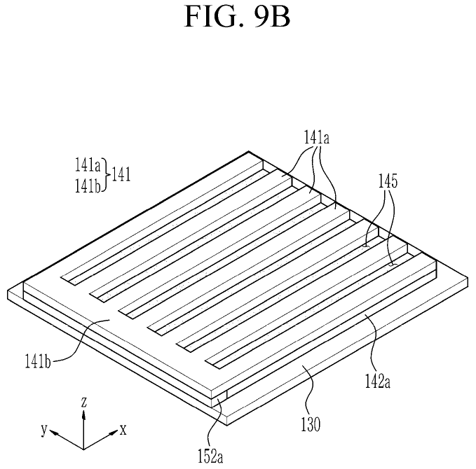

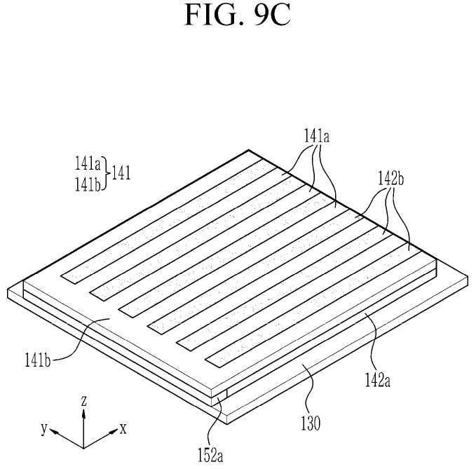

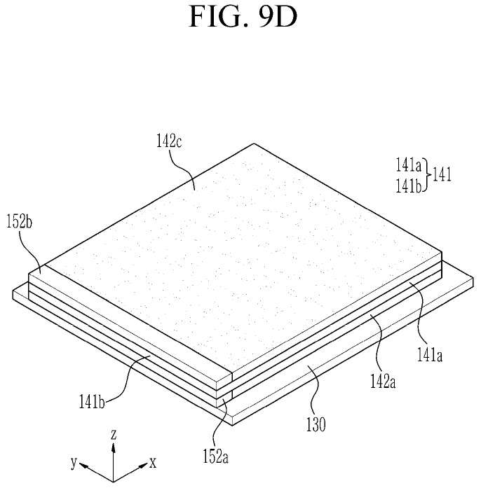

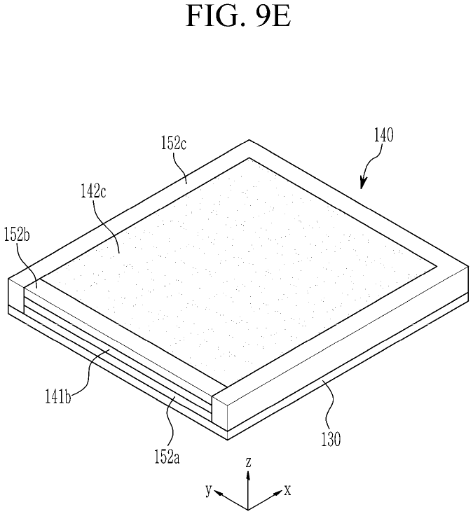

FIGS. 9A to 9E are views illustrating processes of the second step.

Referring to FIG. 9A, the solid electrolyte layer 130 may be prepared, and the first layer 142a may be formed by printing an active material paste on the solid electrolyte layer 130 and then drying the active material paste. The first layer 142a may be a first active material layer. Subsequently, a first margin portion 152a may be formed by printing an insulating paste on the solid electrolyte layer 130 and then drying the insulating paste. The first margin portion 152a may contact one side edge (a left side edge) of the first layer 142a in the plane direction. On the other hand, the first margin portion 152a may be made of a material having ionic conductivity (or electrical conductivity) similar to the ionic conductivity (or electrical conductivity) of the solid electrolyte, and may be made of the material with ionic conductivity (or electrical conductivity) similar to the ionic conductivity (or electrical conductivity) of the solid electrolyte and an insulating material.

Referring to FIG. 9B, the current collector 141 may be formed by printing a conductive paste on the first layer 142a and the first margin portion 152a and drying the conductive paste. The current collector 141 may include the plurality of first current collector portions 141a disposed at a distance from each other by the plurality of slits 145 and the second current collector portion 141b in contact with one side end portion (a left side end portion) of the plurality of first current collector portions 141a in the plane direction. The plurality of first current collector portions 141a may have a rod shape parallel to the first direction, and the second current collector portion 141b may have a rod shape parallel to the second direction.

Referring to FIG. 9C, the second layer 142b may be formed by printing an active material paste in the plurality of slits 145 and then drying the paste. The second layer 142b may be a second active material layer. The second layer 142b may be in contact with the first layer 142a in the stacking direction, and may completely fill the plurality of slits 145.

Referring to FIG. 9D, the third layer 142c may be formed by printing an active material paste on the current collector 141 and the second layer 142b and then drying the paste. The third layer 142c may be a third active material layer. The third layer 142c may cover all of the plurality of first current collector portions 141a, all of a plurality of second layers 142b, and a portion of the second current collector portion 141b. The third layer 142c may contact the plurality of second layers 142b in the stacking direction. Subsequently, a second margin portion 152b may be formed by printing an insulating paste on the second current collector portion 141b and then drying the paste. The second margin portion 152b may contact one side edge (a left side edge) of the third layer 142c in the plane direction. On the other hand, the second margin portion 152b may be made of a material having ionic conductivity (or electrical conductivity) similar to the ionic conductivity (or electrical conductivity) of the solid electrolyte, and may be made of the material with ionic conductivity (or electrical conductivity) similar to the ionic conductivity (or electrical conductivity) of the solid electrolyte and an insulating material.

Referring to FIG. 9E, a third margin portion 152c may be formed by printing an insulating paste at three edges of four edges of a stack including the first to third layers 142a, 142b, and 142c, the first and second margin portions 152a and 152b, and the current collector 141 except for one side edge (a left side edge) where the edge of the second current collector portion 141b is disposed and then drying the insulating paste. The third margin portion 152c may contact the three edges of the stack in the plane direction, and the third margin portion 152c may have the same thickness as the stack. On the other hand, the third margin portion 152c may be made of a material having ionic conductivity (or electrical conductivity) similar to the ionic conductivity (or electrical conductivity) of the solid electrolyte, and may be made of the material with ionic conductivity (or electrical conductivity) similar to the ionic conductivity (or electrical conductivity) of the solid electrolyte and an insulating material.

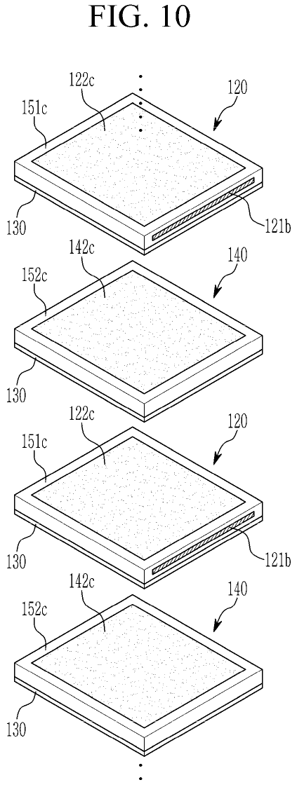

FIG. 10 is a view illustrating a process of the third step

Referring to FIG. 10, the cell stack may be formed by alternately stacking the positive electrode layer 120 and the negative electrode layer 140 with the solid electrolyte layer 130 interposed between the positive electrode layer 120 and the negative electrode layer 140. The outer insulating layer and the protective layer (not shown) may be additionally disposed at the upper outermost portion of the cell stack, and the outer insulating layer and the protective layer (not shown) may be additionally disposed at the lower outermost portion of the cell stack. Thereafter, the external positive electrode and the external negative electrode (not shown) may be disposed at both surfaces of the cell stack to comprise the all-solid-state battery.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

| | |
|---|---|
| 100: all-solid-state battery | 120, 140: electrode layer |
| 120: positive electrode layer | 121: positive electrode current collector |
| 122: positive electrode active material layer | |
| 140: negative electrode layer | |
| 141: negative electrode current collector | |
| 142: negative active material layer | |
| 125, 145: slit | 121a, 141a: first current collector portion |
| 121b, 141b: second current collector portion | 130: solid electrolyte layer |
| 135, 136: outer insulating layer | 137, 138: protective layer |
| 151, 152: margin portion | 151: first margin portion |
| 152: second margin portion | 161: external positive electrode |
| 162: external negative electrode | |

1. An all-solid-state battery, comprising:
a solid electrolyte layer; and
a plurality of electrode layers disposed in a stacking direction with the solid electrolyte layer interposed between the plurality of electrode layers,
wherein at least one of the plurality of electrode layers comprises:
a current collector that includes a plurality of first current collector portions disposed at a distance from each other by a plurality of slits and a second current collector portion contacting one side end portions of the plurality of first current collector portions in a plane direction; and
an electrode active material layer disposed in the plurality of slits and also disposed at at least one surface of the current collector.

2. The all-solid-state battery of claim 1, wherein the plurality of electrode layers includes a first electrode layer and a second electrode layer alternately disposed in the stacking direction, and the second current collector portion of the first electrode layer and the second current collector portion of the second electrode layer are disposed on opposing sides in a first direction of a cell stack including the plurality of electrode layers.

3. The all-solid-state battery of claim 2, wherein in the first electrode layer, the plurality of first current collector portions has a rod shape parallel to the first direction and the second current collector portion is in contact with the one side end portions of the plurality of first current collector portions in the plane direction.

4. The all-solid-state battery of claim 3, wherein in the first electrode layer, the second current collector portion has a rod shape parallel to a second direction of the cell stack, and an edge of the second current collector portion is exposed to one side surface of the cell stack.

5. The all-solid-state battery of claim 4, further comprising a first external electrode disposed at the one side surface of the cell stack to contact the edge of the second current collector portion of the first electrode layer.

6. The all-solid-state battery of claim 5, further comprising a margin portion disposed at edges of the first electrode layer except for an edge of the second current collector portion of the first electrode layer which is connected to the first external electrode.

7. The all-solid-state battery of claim 2, wherein in the second electrode layer, the plurality of first current collector portions has a rod shape parallel to the first direction and the second current collector portion is in contact with the other side end portions of the plurality of first current collector portions in the plane direction.

8. The all-solid-state battery of claim 7, wherein in the second electrode layer, the second current collector portion has a rod shape parallel to a second direction of the cell stack, and an edge of the second current collector portion is exposed to the other side surface of the cell stack.

9. The all-solid-state battery of claim 8, further comprising a second external electrode disposed at the other side surface of the cell stack to contact the edge of the second current collector portion of the second electrode layer.

10. The all-solid-state battery of claim 9, further comprising a margin portion disposed at edges of the second electrode layer except for an edge of the second current collector portion of the second electrode layer which is connected to the second external electrode.

11. The all-solid-state battery of claim 1, wherein the electrode active material layer is disposed on opposing surfaces of the current collector in the stacking direction.

12. An all-solid-state battery, comprising:
a solid electrolyte layer; and
a plurality of electrode layers disposed in a stacking direction with the solid electrolyte layer interposed between the plurality of electrode layers,
wherein at least one of the plurality of electrode layers comprises:
a current collector in which an active material accommodating portion is disposed; and
an electrode active material layer disposed in the active material accommodating portion and also disposed at at least one surface of the current collector.

13. The all-solid-state battery of claim 12, wherein the active material accommodating portion includes a plurality of slits in the current collector.

14. The all-solid-state battery of claim 13, wherein the current collector includes a plurality of first current collector portions disposed at a distance from each other by the plurality of slits and a second current collector portion contacting one side end portions of the plurality of first current collector portions in a plane direction.

15. The all-solid-state battery of claim 14, further comprising a margin portion disposed at edges of the at least one of the plurality of electrode layers except for an edge of the second current collector portion of the at least one of the plurality of electrode layers.

16. The all-solid-state battery of claim 14, wherein the electrode active material layer includes a first layer disposed at the one surface of the current collector, a plurality of second layers disposed in the plurality of slits, and a third layer disposed at the other surface of the current collector, and the first layer and the third layer are integrally connected by the plurality of second layers.

17. A manufacturing method of the all-solid-state battery, comprising:
forming an electrode layer on a solid electrolyte layer; and
repeatedly stacking the solid electrolyte layer and the electrode layer,
wherein the forming of the electrode layer comprises:
printing a first active material layer on the solid electrolyte layer;
printing a current collector that includes a plurality of slits on the first active material layer;
printing a plurality of second active material layers to fill the plurality of slits; and
printing a third active material layer on the current collector and on the plurality of second active material layers.

18. The manufacturing method of claim 17, wherein the printing of the current collector includes printing the current collector that includes a plurality of first current collector portions disposed at a distance from each other by the plurality of slits and a second current collector portion contacting one side end portions of the plurality of first current collector portions in a plane direction.

19. The manufacturing method of claim 18, further comprises:
forming a margin portion at edges of the electrode layer except for an edge of the second current collector portion.

20. The manufacturing method of claim 18, wherein the repeatedly stacking the solid electrolyte layer and the electrode layer includes alternately stacking a first electrode layer and a second electrode layer, the second current collector portion of the first electrode layer is printed to be in contact with the one side end portions of the plurality of first current collector portions in the plane direction, the second current collector portion of the second electrode layer is printed to be in contact with the other side end portions of the plurality of first current collector portions in the plane direction, and the second current collector portion of the first electrode layer and the second current collector portion of the second electrode layer are disposed on opposing sides in a first direction of a cell stack including the stacked electrode layers.
